(19) United States
(12) Patent Application Publication
(10) Pub. No.: US 2020/0130349 A1
(43) Pub. Date: Apr. 30, 2020

(54) INTERMEDIATE TRANSFER BODY, IMAGE FORMING DEVICE, AND IMAGE FORMING METHOD

(71) Applicant: Konica Minolta, Inc., Tokyo (JP)

(72) Inventors: Satoru SHIBUYA, Chiryu-shi (JP); Takuya Okada, Toyokawa-shi (JP)

(21) Appl. No.: 16/657,673

(22) Filed: Oct. 18, 2019

(30) Foreign Application Priority Data
Oct. 30, 2018 (JP) 2018-204112

(51) Int. Cl. B41J 2/005

(52) U.S. Cl. CPC B41J 2/0057

(57) ABSTRACT

An intermediate transfer body used for image formation using an active energy ray includes a transmissive member that is disposed on an outermost layer of the intermediate transfer body and transmits an active energy ray, and a reflective member that reflects the active energy ray that has passed through the transmissive member to a front layer side of the intermediate transfer body.

The entire disclosure of Japanese patent Application No. 2018-204112, filed on Oct. 30, 2018, is incorporated herein by reference in its entirety.

### BACKGROUND

### Technological Field

The present invention relates to an intermediate transfer body, an image forming device, and an image forming method.

### Description of the Related art

An inkjet method can manufacture an image simply and inexpensively, and is therefore applied to various printing fields including various types of printing and special printing such as marking, fine line formation, and a color filter. Particularly, the inkjet method makes digital printing possible without using a plate, and is therefore particularly suitable for applications in which various images are formed in small amounts.

When an image is formed on a recording medium that absorbs ink, such as paper, by the inkjet method, a part of the ink that has been discharged from an inkjet head and has landed on the recording medium penetrates into the recording medium. Therefore, when it is attempted to reduce cost of image formation by reducing the amount of ink used, a contrast ratio of an image is lowered, and unevenness tends to occur in a formed image. Meanwhile, when the viscosity of ink is reduced in order to suppress penetration of the ink into the recording medium and to facilitate spread of the ink on a surface of the recording medium, the ink is likely to bleed, and it is difficult to form a high-definition image.

Meanwhile, if an intermediate image is formed on a surface of an intermediate transfer body into which ink does not easily penetrate, and then the intermediate image is transferred onto a recording medium, an image with a high contrast ratio can be formed even with a smaller amount of ink, and bleeding of ink can also be suppressed. Therefore, it is expected that a high-definition image can be formed at lower cost.

At this time, in order to make it possible to form a higher-definition image easily, a method for thickening ink droplets constituting an intermediate image formed on a surface of an intermediate transfer body to suppress crushing of the ink droplets by a pressure at the time of transfer has been studied.

For example, JP 2015-155201 A describes an intermediate transfer body for water-based ink, obtained by laminating a layer containing an infrared reflection pigment and a top coat layer containing an infrared absorbing material in this order on a substrate. According to JP 2015-155201 A, in the intermediate transfer body, the emitted infrared ray is reflected by the infrared reflection pigment, returned to the top coat layer, absorbed by the infrared absorbing material in the top coat layer, and converted into heat. The intermediate transfer body can efficiently thicken (dry) ink by efficiently converting an infrared ray into heat in the top coat layer in this way.

Note that JP 2013-86354 A describes a substrate for an ultraviolet curable inkjet printing in which a coating layer containing a white pigment and a black pigment at a ratio of 56:1 to 27:1 is disposed on a surface to which an ultraviolet curable ink is applied, and the surface to which an ultraviolet curable ink is applied has an integral spectral reflectance of 100 or more for light with a wavelength of 360 nm or more and 450 nm or less. According to JP 2013-86354 A, in the substrate, a substrate surface reflects an emitted ultraviolet ray. The substrate enhances curability of ultraviolet curable ink droplets thus applied to the substrate surface at a boundary surface with the substrate and at the inside of the ultraviolet curable ink droplets and can improve adhesion of the ink droplets to the substrate.

As described in JP 2015-155201 A, if a composition such as ink is sufficiently thickened on an intermediate transfer body, crushing of the composition droplets at the time of transfer is suppressed, and it is expected to be able to form a higher-definition image. However, JP 2015-155201 A describes an intermediate transfer body for water-based ink used for drying ink by heat generation from the intermediate transfer body. Even if the intermediate transfer body described in JP 2015-155201 A is applied to image formation using an active energy ray curable composition such as an ultraviolet curable ink, a similar effect cannot be expected.

Furthermore, according to the findings of the present inventors, when an active energy ray curable composition is thickened (temporarily cured) on an intermediate transfer body to such an extent that crushing does not occur at the time of transfer, a front surface side of the composition (front surface side of the composition (ink) in contact with a recording medium at the time of transfer) is excessively cured by an emitted active energy ray. When the front surface side of the composition is excessively cured, wettability of the front surface side of the composition is excessively reduced. Therefore, adhesion between the composition and a recording medium at the time of transfer is reduced. Meanwhile, as described in JP 2013-86354 A, even when an active energy ray is reflected on a surface of an intermediate transfer body to facilitate curing of a back surface side (front surface side of a composition (ink) in contact with the intermediate transfer body) where crushing easily occurs in the composition, the front surface side of the composition is excessively cured, and adhesion between the composition and a recording medium at the time of transfer tends to be reduced.

### SUMMARY

The present invention has been achieved on the basis of the above findings. An object of the present invention is to provide an intermediate transfer body that can enhance adhesion of an active energy ray curable composition to a recording medium by transfer while suppressing crushing of the active energy ray curable composition at the time of transfer, an image forming device including the intermediate transfer body, and an image forming method using the intermediate transfer body.

To achieve the abovementioned object, according to an aspect of the present invention, there is provided an intermediate transfer body used for image formation using an active energy ray, and the intermediate transfer body reflecting one aspect of the present invention comprises a transmissive member that is disposed on an outermost layer of the intermediate transfer body and transmits an active energy ray, and a reflective member that reflects the active energy ray that has passed through the transmissive member to a front layer side of the intermediate transfer body.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention:

FIG. 1 is a schematic view illustrating a partial cross section of an intermediate transfer body according to a first embodiment of the present invention;

FIG. 2 is a schematic view illustrating how an active energy ray curable composition constituting an intermediate image formed on a surface of a transmissive layer is thickened (temporarily cured) by irradiating a surface of an intermediate transfer body with an active energy ray;

FIG. 3 is a schematic view illustrating how an intermediate image including a thickened active energy ray curable composition is transferred onto a recording medium that moves on a conveyance path;

FIG. 4 is a schematic view illustrating an exemplary configuration of an image forming device according to a second embodiment of the present invention; and

FIG. 5 is a flowchart of an image forming method according to a third embodiment of the present invention.

### DETAILED DESCRIPTION OF EMBODIMENTS

Hereinafter, one or more embodiments of the present invention will be described with reference to the drawings. However, the scope of the invention is not limited to the disclosed embodiments.

1. Intermediate Transfer Body

A first embodiment of the present invention relates to an intermediate transfer body obtained by laminating one or more layers on a substrate and used for image formation with an active energy ray curable composition. The intermediate transfer body includes, in an outermost layer, a transmissive member that transmits an active energy ray and a reflective member that reflects the active energy ray that has passed through the transmissive member to a front layer side of the intermediate transfer body.

Note that the active energy ray means an energy ray having an effect of polymerizing and crosslinking a photopolymerizable compound contained in an active energy ray curable composition to cure the active energy ray curable composition. Examples of the active energy ray include an ultraviolet ray, an electron beam, an α ray, a γ ray, and an X-ray. The active energy ray is preferably an ultraviolet ray or an electron beam from viewpoints of safety and being able to cause the polymerization and crosslinking even with a lower energy amount.

The active energy ray curable composition means a composition cured by irradiation with an active energy ray. The active energy ray curable composition is preferably a liquid composition. Examples of the active energy ray curable composition include a known active energy ray curable ink, particularly a known active energy ray curable inkjet ink.

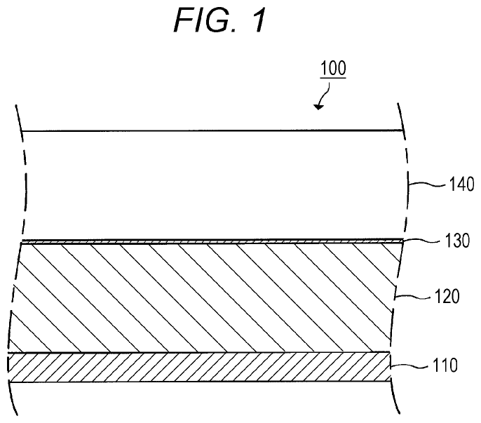

FIG. 1 is a schematic view illustrating a partial cross section of an intermediate transfer body 100 according to the present embodiment. The intermediate transfer body 100 includes a substrate 110, and an elastic layer 120, a reflective layer 130, and a transmissive layer 140 as an outermost layer laminated in this order on the substrate 110.

The substrate 110 only needs to be a substrate included in an intermediate transfer body used for image formation using an active energy ray, particularly used for image formation with an active energy ray curable composition, and can be formed of a resin material or a metal material. Examples of the resin material of the substrate 110 include a resin having a structural unit containing a benzene ring, such as aromatic polyimide (PI), aromatic polyamide imide (PAI), polyphenylene sulfide (PPS), aromatic polyether ether ketone (PEEK), aromatic polycarbonate (PC), or aromatic polyether ketone (PEK), polyvinylidene fluoride (PVDF), and a mixture and a copolymer thereof. Examples of metal material of the substrate 110 include a metal such as steel, aluminum, or stainless steel.

The thickness of the substrate 110 only needs to be set to such a degree that can impart sufficient strength to the intermediate transfer body 100, and can be, for example, 30 μm or more and 500 μm or less.

The elastic layer 120 only needs to be an elastic layer included in an intermediate transfer body used for image formation with an active energy ray curable composition. Examples of a material of the elastic layer 120 include a rubber such as a silicone rubber (SR), a chloroprene rubber (CR), a nitrile rubber (NBR), or an epichlorohydrin rubber (ECO), an elastomer, and an elastic resin.

The thickness of the elastic layer 120 only needs to be set to such a degree that can impart sufficient elasticity to a surface of the transmissive layer 140, and can be, for example, 100 μm or more and 500 μm or less, and preferably 200 μm or more and 400 μm or less.

The reflective layer 130 is disposed in contact with the transmissive layer 140 as an outermost layer and includes the reflective member. The reflective layer 130 reflects an active energy ray that has been incident on the intermediate transfer body 100 from a side of the transmissive layer 140 and has passed through the transmissive layer 140 and causes the active energy ray to travel to a front surface side of the intermediate transfer body (a front surface side to which an active energy ray curable composition is applied).

The reflective layer 130 may be formed by forming a metal as a reflective member into a film shape, or may be formed by forming a reflective member containing a particulate reflective material into a film shape.

The metal only needs to be a metal that can reflect an active energy ray. Examples of the metal include aluminum, silver, gold, and mercury. Among these metals, aluminum is preferable because aluminum is lightweight and inexpensive, and makes it easy to manufacture the reflective layer 130. For example, the reflective layer 130 can be a layer formed by vapor-depositing aluminum.

The particulate reflective material only needs to be formed of particles that can reflect an active energy ray. Examples of the particulate reflective material include fine particles of titanium dioxide, calcium carbonate, barium sulfate, and silica. Among these materials, titanium dioxide and calcium carbonate are preferable, and titanium dioxide is more preferable because of high reflectivity.

At this time, the reflective layer 130 can be formed by forming a reflective member in which the particulate reflective material is dispersed in a resin. Examples of the resin include an acrylic resin, a polyester-based resin, a urethane-based resin, a fluorine-based resin, and a silicone-based resin. Among these resins, an acrylic resin and a polyester-based resin are preferable because of high durability.

At this time, the reflective member preferably contains the particulate reflective material in an amount of 10% by mass or more and 50% by mass or less with respect to the total mass of the reflective member from a viewpoint of achieving both reflectivity of an active energy ray by the reflective layer 130 and strength of the reflective layer 130.

As the reflective member, a member that transmits an ultraviolet ray is used when an ultraviolet ray is used for thickening (temporarily curing) the active energy ray curable composition, and a member that transmits an electron beam is used when an electron beam is used for thickening (temporarily curing) the active energy ray curable composition. A material of the reflective member only needs to be selected according to the type of active energy ray used for thickening the active energy ray curable composition.

The reflective member that transmits an ultraviolet ray can be, for example, a member having an integral spectral reflectance of 100 or more for light with a wavelength of 360 nm or more and 450 nm or less. The integral spectral reflectance can be a value measured by a known measurement method using an integrating sphere.

The thickness of the reflective layer 130 only needs to be set to such a degree that an active energy ray that has passed through the transmissive layer 140 can be sufficiently reflected. For example, when the reflective layer 130 is formed by forming a metal that is a reflective member into a film shape, the thickness of the reflective layer 130 can be 50 nm or more and 200 nm or less, and when the reflective layer 130 is formed by forming a reflective member containing a particulate reflective material into a film shape, the thickness of the reflective layer 130 can be 50 μm or more and 200 μm or less.

The transmissive layer 140 is the outermost layer of the intermediate transfer body 100, and is formed such that an intermediate image to be transferred onto a recording medium is formed in contact with a surface of the transmissive layer 140 by application of an active energy ray curable composition. In addition, the transmissive layer 140 is formed of a transmissive member that transmits an active energy ray, transmits an emitted active energy ray, and causes the active energy ray to travel in a direction of the reflective layer 130.

The transmissive member only needs to be a member capable of transmitting an active energy ray. Examples of the transmissive member include a transparent resin such as polypropylene (PP), perfluoroalkoxy alkane (PFA), an ethylene-tetrafluoroethylene copolymer (ETFE), polyimide (PI), polyethylene terephthalate (PET), or an acrylic resin. The transmissive member only needs to be determined among these resins in consideration of followability to the substrate 110, adhesion to the reflective layer 130, durability, the type of active energy ray curable composition to be applied, and the like. For example, polypropylene (PP) is preferable from a viewpoint of adjusting wettability of an applied active energy ray curable composition.

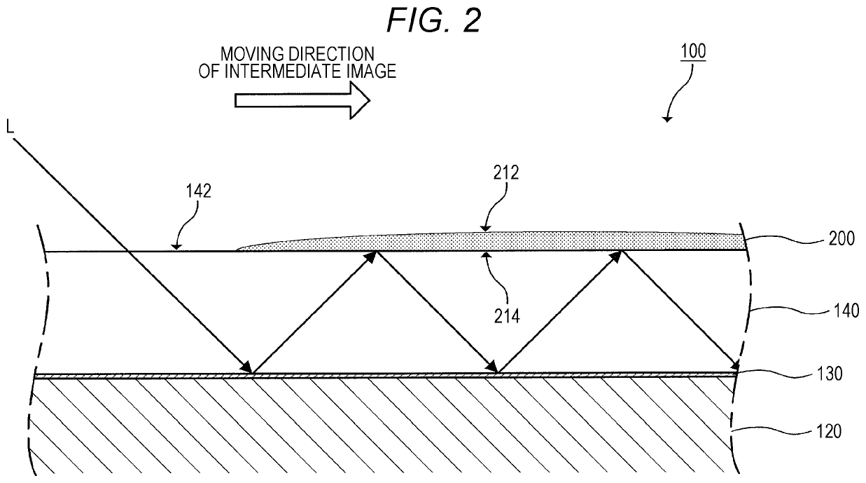

FIG. 2 is a schematic view illustrating how an active energy ray curable composition constituting an intermediate image 200 formed on a surface of the transmissive layer 140 is thickened (temporarily cured) by irradiating a surface of the intermediate transfer body 100 with an active energy ray. An arrow in FIG. 2 indicates a moving direction of the intermediate image 200 (rotating direction of the intermediate transfer body 100). FIG. 2 illustrates an exemplary light path of a ray included in an active energy ray emitted at this time.

As illustrated in FIG. 2, at this time, by limiting the irradiation amount of an active energy ray to a front side surface 212 which is a surface in contact with a recording medium at the time of transfer in the intermediate image 200, an area 142 where the intermediate image 200 is not formed on the surface of the intermediate transfer body 100 (surface of the transmissive layer 140) is selectively irradiated with an active energy ray L. Note that selective irradiation means that the irradiation amount of the active energy ray L to the area 142 where the intermediate image 200 is not formed is larger than the irradiation amount of the active energy ray L to the front side surface 212 of the intermediate image 200.

The emitted active energy ray L enters the transmissive layer 140 from the area 142, travels toward the reflective layer 130 inside the transmissive layer 140, then is reflected by the reflective layer 130 at an interface between the transmissive layer 140 and the reflective layer 130, travels toward a front surface side of the intermediate transfer body (in a direction in which the intermediate image 200 exists) inside the transmissive layer 140, and is emitted to one area of a back side surface 214 which is a surface in contact with the intermediate transfer body in the intermediate image 200. A part of the emitted active energy ray L is used for curing the active energy ray curable composition constituting the above one area of the intermediate image 200, and the remaining part of the emitted active energy ray L is further reflected by the back side surface 214 and travels in a direction of the reflective layer 130 inside the transmissive layer 140. Thereafter, the active energy ray L is further reflected by the reflective layer 130 and travels toward a front surface side of the intermediate transfer body inside the transmissive layer 140, is emitted to another area of the back side surface 214 of the intermediate image 200. A part of the active energy ray L is used for curing the active energy ray curable composition constituting the above other area of the intermediate image 200, and the remaining part of the emitted active energy ray L is further reflected by the back side surface 214 and travels in a direction of the reflective layer 130 inside the transmissive layer 140.

In this way, the active energy ray L selectively emitted to the area 142 where the intermediate image is not formed on the surface of the intermediate transfer body 100 travels inside the transmissive layer 140 while being reflected internally, and is emitted to the active energy ray curable composition constituting the intermediate image 200 from a side of the back side surface 214. Therefore, the active energy ray curable composition constituting the intermediate image 200 is cured from the side of the back side surface 214, and is thickened (temporarily cured) such that the hardness thereof on the side of the back side surface 214 becomes higher, and the hardness thereof on a side of the front side surface 212 side becomes lower.

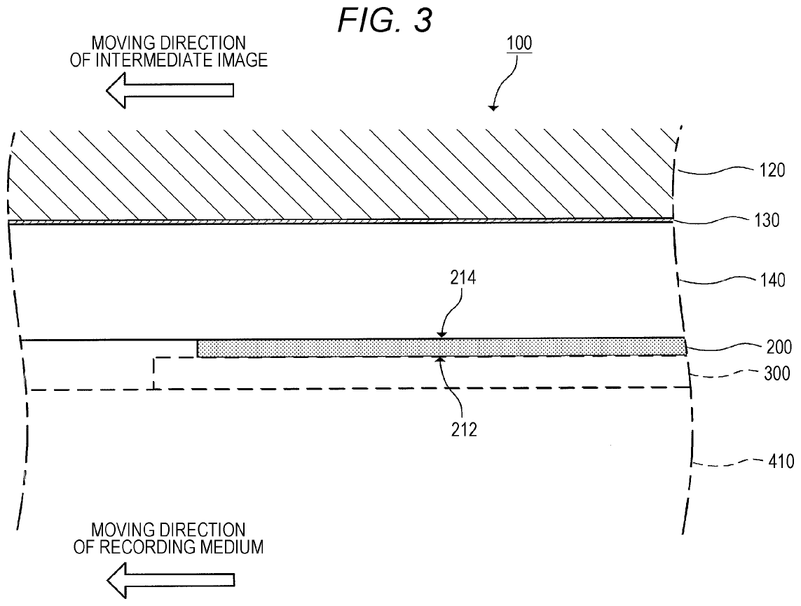

FIG. 3 is a schematic view illustrating how the intermediate image 200 including the thickened active energy ray curable composition is transferred onto a recording medium 300 that moves on a conveyance path 410. An arrow in FIG. 3 indicates a moving direction of the intermediate image 200 (rotating direction of the intermediate transfer body 100) and a moving direction of the recording medium 300.

As illustrated in FIG. 3, at this time, in the intermediate image 200, the front side surface 212 in which the hardness of the active energy ray curable composition is lower, and a predetermined wettability is maintained is in contact with the recording medium 300. Therefore, the intermediate image 200 has sufficient adhesion to the recording medium 300. As described above, in the intermediate transfer body 100, by lowering the hardness of the active energy ray curable composition on the front side surface 212 of the intermediate image 200, it is possible to suppress reduction in adhesion between the active energy ray curable composition and the recording medium 300 due to excessive curing of the active energy ray curable composition.

Meanwhile, at this time, the intermediate image 200 is in close contact with the recording medium 300 in such a manner that the back side surface 214 in which the hardness of the active energy ray curable composition is higher is pressed against the recording medium 300. Therefore, crushing of the composition due to the pressing is unlikely to occur. Therefore, in the intermediate transfer body 100, by further increasing the hardness of the active energy ray curable composition on the back side surface 214 of the intermediate image 200, crushing of the composition due to a pressure at the time of transfer can be suppressed.

The transmissive member has a transmittance preferably of 70% or more, more preferably of 80% or more, still more preferably of 90% or more for light with a wavelength of 360 nm or more and 450 nm or less from a viewpoint of causing the active energy ray L internally reflected inside the transmissive layer 140 to sufficiently travel inside the transmissive layer 140. The transmittance can be a value measured by using a known spectrophotometer with an optical path length of 10 mm.

Alternatively, the transmissive member is preferably substantially free of a material that reflects an active energy ray from a viewpoint of causing the active energy ray L internally reflected inside the transmissive layer 140 to sufficiently travel inside the transmissive layer 140. The material that reflects an active energy ray means a material having an integral spectral reflectance of 100 or more for light with a wavelength of 360 nm or more and 450 nm or less. The term “substantially free” means that the ratio of a volume occupied by the material that reflects an active energy ray in the transmissive layer 140 is 0.1% by volume or less with respect to the total volume of the transmissive layer 140.

The thickness of the transmissive layer 140 is preferably 5 μm or more, more preferably 50 μm or more, and still more preferably 200 μm or more from a viewpoint of sufficiently causing internal reflection of an active energy ray between the reflective layer 130 and the intermediate image 200. An upper limit of the thickness of the transmissive layer 140 is not particularly limited, but is preferably 500 μm or less.

Note that in the above description, the transmissive member is formed into a film shape to form the transmissive layer 140 as the outermost layer. However, the transmissive member may be disposed only in a part of the outermost layer, an intermediate image may be formed in contact with the transmissive member, and the transmissive member may be irradiated with an active energy ray.

Furthermore, in the above description, the reflective member is formed into a film shape to form the reflective layer 130 in contact with the outermost layer. However, the reflective member may be disposed at a position as a part of the substrate or the elastic layer in contact with the transmissive member.

The intermediate transfer body can be used for a so-called intermediate transfer type image forming method for forming an intermediate image on an intermediate transfer body using an active energy ray curable composition, and transferring the formed intermediate image from the intermediate transfer body onto a recording medium. A method for forming the intermediate image is not particularly limited, and a known method such as spray coating, an immersion method, screen printing, gravure printing, offset printing, or an inkjet method can be used. However, since an image formed of an assembly of dots of droplets of an active energy ray curable composition (ink) is formed, at the time of image formation by the inkjet method during which crushing of ink droplets is more likely to occur, curing that can suppress crushing of ink by the intermediate transfer body is remarkably exhibited.

2. Image Forming Device

A second embodiment of the present invention relates to an image forming device including the intermediate transfer body according to the first embodiment described above.

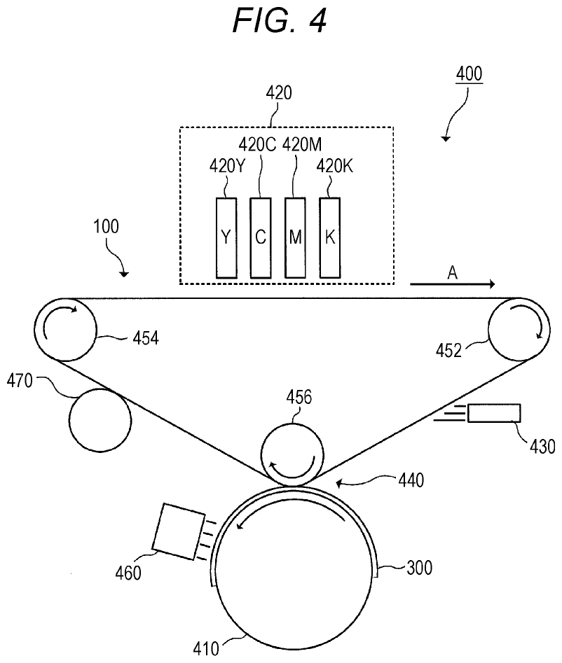

FIG. 4 is a schematic view illustrating an exemplary configuration of an image forming device 400 according to the present embodiment. The image forming device 400 includes a conveyance path 410 that conveys a recording medium 300, the intermediate transfer body 100 according to the first embodiment, disposed so as to face a surface of the conveyance path 410 on which the recording medium 300 is conveyed, an intermediate image former 420 that applies an active energy ray curable composition to a surface of the intermediate transfer body 100 to form an intermediate image, a thickener 430 that irradiates the surface of the intermediate transfer body 100 with an active energy ray to thicken the active energy ray curable composition, and a transferer 440 that transfers an intermediate image including the thickened active energy ray curable composition onto the recording medium 300. The image forming device 400 further includes support rollers 452, 454, and 456 that stretch the intermediate transfer body 100 having an endless belt shape, a curer 460 that irradiates a surface of the conveyance path 410 with an active energy ray for curing (finally curing) an active energy ray curable composition to constituting an intermediate image, and a cleaner 470 that removes the active energy ray curable composition remaining on a surface of the intermediate transfer body 100 without being transferred onto the recording medium 300 from the surface of the intermediate transfer body 100.

The conveyance path 410 is formed of, for example, a metal drum, and conveys the recording medium 300 onto which an intermediate image is transferred. The conveyance path 410 is disposed in contact with a surface of a part of the intermediate transfer body 100, and the support roller 456 presses the contact surface of the intermediate transfer body 100 to form a transfer nip. The conveyance path 410 may have a claw (not illustrated) that fixes a leading end of the recording medium 300. The conveyance path 410 fixes the leading end of the recording medium 300 to the claw and rotates in a counterclockwise direction in FIG. 4 to convey the recording medium 300 to the transfer nip.

The intermediate transfer body 100 is the intermediate transfer body according to the first embodiment described above. The intermediate transfer body 100 is stretched by the support rollers 452, 454, and 456, and conveys an intermediate image formed on a surface of the intermediate transfer body 100 by the intermediate image former 420 to the transferer 440.

The intermediate image former 420 is an ink applying unit that forms an intermediate image by the inkjet method in the present embodiment, and includes inkjet heads 420Y, 420M, 420C, and 420K that discharge an active energy ray curable composition (inkjet ink) of respective colors of yellow (Y), magenta (M), cyan (C), and black (K) from nozzles and cause the discharged active energy ray curable composition to land on a surface of the intermediate transfer body 100. The inkjet heads 420Y, 420M, 420C, and 420K cause the active energy ray curable composition (inkjet ink) of the respective colors to land on the surface of the intermediate transfer body 100 at a position corresponding to an image to be formed, and thereby forms an intermediate image.

The thickener 430 irradiates the surface of the intermediate transfer body 100 with an active energy ray while the intermediate image formed by the intermediate image former 420 is conveyed to the transferer 440. The emitted active energy ray is incident on the active energy my curable composition constituting the intermediate image to thicken (temporarily cure) the active energy ray curable composition.

On the surface of the rotating intermediate transfer body 100, an area where the intermediate image 200 is formed by the intermediate image former 420 and an area 142 where the intermediate image 200 is not formed are mixed (see FIG. 2). Preferably, the thickener 430 selectively irradiates the area 142 where the intermediate image 200 is not formed on the surface of the intermediate transfer body 100 with an active energy ray.

For example, when the intermediate image former 420 forms a plurality of the intermediate images 200 on the surface of intermediate transfer body 100, the thickener 430 preferably irradiates the surface of the intermediate transfer body 100 among the plurality of intermediate images 200 with an active energy ray. The plurality of intermediate images means a plurality of intermediate images separated from one another and having no contact point.

The active energy ray thus emitted enters a transmissive layer 140 of the intermediate transfer body 100, travels in a direction of the reflective layer 130, is then reflected by the reflective layer 130 and the back side surface 214 of the intermediate image 200, and travels inside the transmissive layer 140 while being emitted to the active energy ray curable composition from the back side surface 214 of the intermediate image 200. As a result, the active energy ray curable composition constituting the intermediate image 200 is cured from the side of the back side surface 214 of the intermediate image 200, and is thickened (temporarily cured) such that the hardness thereof on the side of the back side surface 214 becomes higher, and the hardness thereof on a side of the front side surface 212 becomes lower.

At this time, the irradiation amount of the active energy ray to the area 142 only needs to be such an amount that the active energy ray curable composition constituting the back side surface 214 of the intermediate image 200 is sufficiently cured so as to make crushing of the active energy ray curable composition difficult at the time of transfer by traveling of the active energy ray inside the transmissive layer 140 due to internal reflection. The light quantity of the active energy ray emitted at this time can be, for example, 5% or more and 40% or less with respect to the light quantity of the active energy ray for curing the active energy ray curable composition used for image formation.

Furthermore, the irradiation amount of the active energy ray to the front side surface 212 of the intermediate images 200 only needs to be such an amount that the active energy ray curable composition constituting the front side surface of the intermediate image 200 can maintain sufficient wettability with respect to a recording medium at the time of transfer to the recording medium. For example, the front side surface 212 of the intermediate image 200 does not have to be irradiated with an active energy ray intentionally such that the front side surface 212 is not irradiated with the active energy ray except for the active energy ray with which the front side surface 212 is inevitably irradiated.

For example, the irradiation amount of the active energy ray to the area 142 is preferably such an amount that the viscosity of the back side surface 214 of the intermediate image 200 is 2×10⁷ mPa·s or more, and more preferably such an amount that the viscosity of the back side surface 214 of the intermediate image 200 is 2×10⁷ mPa·s or more and 2×10⁸ mPa·s or less. Meanwhile, at this time, the irradiation amount of the active energy ray to the front side surface 212 of the intermediate image 200 is preferably limited such that the viscosity of the front side surface 212 of the intermediate image 200 is 5×10⁶ mPa·s or more and 2×10⁸ mPa·s or less, and preferably 1×10⁷ mPa·s or more and 1×10⁸ mPa·s or less.

At this time, the thickener 430 preferably irradiates the moving surface of the intermediate transfer body 100 with the active energy ray at an angle inclined toward the moving direction. That is, the thickener 430 preferably irradiates the surface of the intermediate transfer body 100 to which the intermediate image 200 to be transferred is conveyed between the intermediate image former 420 and the transferer 440 with the active energy ray at an angle inclined from a side of the intermediate image former 420 on an upstream side toward a side of the transferer 440 on a downstream side. The active energy ray thus emitted is incident on the transmissive layer 140 from a back side of the moving intermediate image 200, and travels inside the transmissive layer 140 in the same direction as the movement of the intermediate image 200 (see FIG. 2). By making the active energy ray incident on the transmissive layer 140 from a back side of the moving intermediate image 200, the timing of the incidence of the active energy ray is easily controlled, and unintentional irradiation with the active energy ray to the front side surface 212 of the intermediate image 200 due to a slight timing deviation is easily suppressed.

The transferer 440 is a portion including the transfer nip where the intermediate transfer body 100 and the conveyance path 410 are closest to each other, and presses a surface of the conveyance path 410 in contact with the intermediate transfer body 100 because the intermediate transfer body 100 is biased in a direction of the conveyance path 410 by the support roller 456. The intermediate image 200 including the active energy ray curable composition formed and conveyed on the surface of the intermediate transfer body 100 and thickened by the thickener 430, and the recording medium 300 disposed and conveyed on the surface of the conveyance path 410 are in contact with each other at the transfer nip, and are pressed from the intermediate transfer body 100 to a side of the conveyance path 410 via the support roller 456. As a result, the intermediate image 200 is transferred onto the recording medium 300.

At this time, the irradiation by the thickener 430 thickens the intermediate image 200 such that the hardness of the intermediate image 200 on a side of the back side surface 214 in contact with and pressed against the intermediate transfer body 100 becomes higher, and the hardness of the intermediate image 200 on a side of the front side surface 212 in contact with the recording medium 300 becomes lower. For this reason, the intermediate image 200 is unlikely to cause crushing of the composition due to pressing at the time of transfer, has sufficient wettability to the recording medium 300 at the time of transfer, and therefore easily enhances adhesion to the recording medium 300.

The curer 460 is disposed on a downstream side of the transferer 440 in a conveyance direction of the recording medium 300 by the conveyance path 410, and irradiates a surface of the conveyance path 410 with an active energy ray. As a result, the curer 460 irradiates the active energy ray curable composition constituting the intermediate image transferred onto the recording medium 300 with an active energy ray to cure (finally cure) the active energy ray curable composition constituting the intermediate image. As a result, a target image is formed on the surface of the recording medium 300.

The cleaner 470 is a cleaning roller such as a web roller or a sponge roller, and is in contact with a surface of the intermediate transfer body 100 on a downstream side of the transferer 440. By drive and rotation of the cleaning roller, the cleaner 470 removes a residual composition (residual coating material) remaining on the surface of the intermediate transfer body 100 without being transferred onto the recording medium 300 in the transferer 440.

Noe that in the above description, the intermediate image is formed on the surface of the intermediate transfer body by the inkjet method. However, a method for forming the intermediate image is not particularly limited, and a known method such as spray coating, an immersion method, screen printing, gravure printing, or offset printing can be used. Among these methods, since an image formed of an assembly of dots of droplets of an active energy ray curable ink is formed, at the time of image formation by the inkjet method during which crushing of ink droplets is more likely to occur, curing that can suppress crushing of ink by the image forming device is remarkably exhibited.

3. Image Forming Method

A third embodiment of the present invention relates to an image forming method using the intermediate transfer body according to the first embodiment described above. The image forming method can be performed, for example, using the image forming device according to the second embodiment described above.

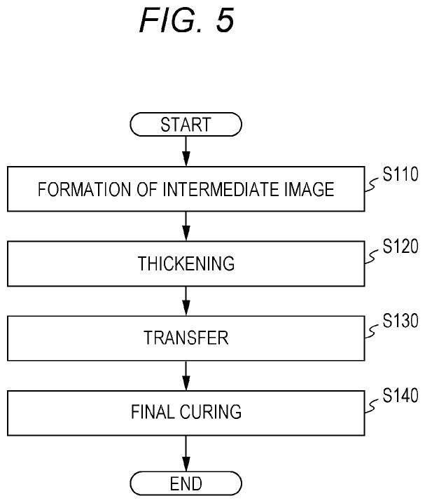

FIG. 5 is a flowchart of the image forming method according to the present embodiment. The image forming method includes: a step of applying an active energy ray curable ink to a surface of the intermediate transfer body to form an intermediate image (step S110); a step of irradiating the surface of the intermediate transfer body with an active energy ray to thicken the active energy ray curable ink (step S120); and a step of transferring an intermediate image including the thickened active energy ray curable ink onto a recording medium (step S130). The image forming method may further include a step of irradiating the intermediate image transferred onto the recording medium with an active energy ray to finally cure the active energy ray curable ink (step S140).

In the step of forming an intermediate image (step S110), an active energy ray curable ink is applied to a surface of the intermediate transfer body according to the first embodiment to form an intermediate image.

A method for forming the intermediate image is not particularly limited, and a known method such as spray coating, an immersion method, screen printing, gravure printing, offset printing, or an inkjet method can be used. However, since an image formed of an assembly of dots of droplets of an active energy ray curable ink is formed, at the time of image formation by the inkjet method during which crushing of composition (ink) droplets is more likely to occur, curing that can suppress crushing of ink by the present embodiment is remarkably exhibited.

In the step of thickening an active energy ray curable composition (step S120), a surface of the intermediate transfer body on which the intermediate image is formed is irradiated with an active energy ray. At this time, preferably, an area where the intermediate image is not formed on the surface of the intermediate transfer body is selectively irradiated with an active energy ray.

For example, when a plurality of intermediate images is formed on a surface of the intermediate transfer body in the step of forming an intermediate image (step S110), in the present step, the surface of the intermediate transfer body among the plurality of intermediate images is preferably irradiated with an active energy ray.

The active energy ray thus emitted enters the transmissive layer of the intermediate transfer body, and travels inside the transmissive layer while being emitted to the active energy ray curable composition from the back side surface of the intermediate image. As a result, the active energy ray curable composition constituting the intermediate image is cured from a side of the back side surface of the intermediate image, and is thickened (temporarily cured) such that the hardness thereof on the side of the back side surface becomes higher, and the hardness thereof on a side of the front side surface becomes lower.

At this time, the irradiation amount of the active energy ray to an area where the intermediate image is not formed only needs to be such an amount that the active energy ray curable composition constituting the back side surface of the intermediate image is sufficiently cured so as to make crushing of the active energy ray curable composition difficult at the time of transfer by traveling of the active energy ray inside the transmissive layer due to internal reflection. The light quantity of the active energy ray emitted at this time can be, for example, 5% or more and 40% or less with respect to the light quantity of the active energy ray for curing the active energy ray curable composition used for image formation.

Furthermore, the irradiation amount of the active energy ray to the front side surface of the intermediate image only needs to be such an amount that the active energy ray curable composition constituting the front side surface of the intermediate image can maintain sufficient wettability with respect to a recording medium at the time of transfer to the recording medium. For example, the front side surface of the intermediate image does not have to be irradiated with an active energy ray intentionally such that the front side surface is not irradiated with the active energy ray except for the active energy ray with which the front side surface is inevitably irradiated.

For example, the irradiation amount of the active energy ray to an area where the intermediate image is not formed is preferably such an amount that the viscosity of the back side surface of the intermediate image is 2×10⁷ mPa·s or more, and more preferably such an amount that the viscosity of the back side surface of the intermediate image is 2×10⁷ mPa·s or more and 2×10⁸ mPa·s or less. Meanwhile, at this time, the irradiation amount of the active energy ray to the front side surface of the intermediate image is preferably limited such that the viscosity of the front side surface of the intermediate image is 5×10⁶ mPa·s or more and 2×10⁸ mPa·s or less, and preferably 1×10⁷ mPa·s or more and 1×10⁸ mPa·s or less.

At this time, the moving surface of the intermediate transfer body is preferably irradiated with the active energy ray at an angle inclined toward the moving direction. That is, the surface of the intermediate transfer body to which the intermediate image to be transferred is conveyed is preferably irradiated with the active energy ray at an angle inclined from an upstream side toward a downstream side. As a result, the timing of the incidence of the active energy ray is easily controlled, and unintentional irradiation with the active energy ray to the front side surface of the intermediate image due to a slight timing deviation is easily suppressed.

In the step of transferring an intermediate image onto a recording medium (step S130), the intermediate image formed on the surface of the intermediate transfer body is transferred onto a surface of the recording medium. For example, it is only required to bring a surface of the intermediate transfer body on which the intermediate image is formed into contact with a surface of the recording medium on which an image is to be formed, and to press the intermediate transfer body against the recording medium.

At this time, the thickening of the active energy ray curable composition (step S120) thickens the intermediate image such that the hardness of the intermediate image on a side of the back side surface in contact with and pressed against the intermediate transfer body becomes higher, and the hardness of the intermediate image on a side of the front side surface in contact with the recording medium becomes lower. For this reason, the intermediate image is unlikely to cause crushing of the composition due to pressing at the time of transfer, has sufficient wettability to the recording medium at the time of transfer, and therefore easily enhances adhesion to the recording medium.

In the step of finally curing an active energy ray curable composition (step S140), the intermediate image transferred onto the recording medium is irradiated with an active energy ray to finally cure the intermediate image. As a result, an image is formed on the recording medium.

4. Active Energy Ray Curable Composition

The active energy ray curable composition is not particularly limited, and only needs to be, for example, a known active energy ray curable composition (inkjet ink) used for image formation by the inkjet method.

4-1. Material of Active Energy Ray Curable Composition

For example, the active energy ray curable composition can contain a photopolymerizable compound that is polymerized and crosslinked by irradiation with an active energy ray and can optionally contain a photopolymerization initiator.

The active energy ray curable composition may further contain, if necessary, a coloring material such as a dye or a pigment, a dispersant for dispersing a pigment, a fixing resin for fixing a pigment to a substrate, a surfactant, a polymerization inhibitor, a pH adjuster, a humectant, an ultraviolet absorber, a gelling agent that causes a composition to undergo a sol-gel phase transition with temperature change, and the like. Only one type or two or more types of the other components may be contained in the composition.

Examples of the photopolymerizable compound include a radically polymerizable compound and a cationically polymerizable compound. The photopolymerizable compound may be a monomer, a polymerizable oligomer, a prepolymer, or a mixture thereof.

The radically polymerizable compound is preferably an unsaturated carboxylate compound, and more preferably a (meth)acrylate. Note that here, “(meth)acrylate” means acrylate or methacrylate, “(meth)acrylic” means acrylic or methacrylic, and “(meth)acryloyl” means acryloyl or methacryloyl.

Examples of a monofunctional (meth)acrylate include isoamyl (meth)acrylate, stearyl (meth)acrylate, lauryl (meth)acrylate, octyl (meth)acrylate, decyl (meth)acrylate, isomyristyl (meth)acrylate, isostearyl (meth)acrylate, 2-ethylhexyl-diglycol (meth)acrylate, 2-hydroxybutyl (meth)acrylate, 2-(meth)acryloyloxyethyl hexahydrophthalic acid, butoxyethyl (meth)acrylate, ethoxydiethylene glycol (meth)acrylate, methoxydiethylene glycol (meth)acrylate, methoxypolyethylene glycol (meth)acrylate, methoxypropylene glycol (meth)acrylate, phenoxyethyl (meth)acrylate, tetrahydrofurfuryl (meth)acrylate, isobornyl (meth)acrylate, 2-hydroxyethyl (meth)acrylate, 2-hydroxypropyl (meth)acrylate, 2-hydroxy-3-phenoxypropyl (meth)acrylate, 2-(meth)acryloyloxyethyl succinic acid, 2-(meth)acryloyloxyethyl phthalic acid, 2-(meth)acryloyloxyethyl-2-hydroxyethyl-phthalic acid, and t-butylcyclohexyl (meth)acrylate.

Examples of a polyfunctional (meth)acrylate include: a bifunctional (meth)acrylate such as triethylene glycol di(meth)acrylate, tetraethylene glycol di(meth)acrylate, polyethylene glycol di(meth)acrylate, tripropylene glycol di(meth)acrylate, polypropylene glycol di(meth)acrylate, 1,4-butanediol di(meth)acrylate, 1,6-hexanediol di(meth)acrylate, 1,9-nonanediol di(meth)acrylate, neopentyl glycol di(meth)acrylate, dimethylol-tricyclodecane di(meth)acrylate, PO adduct of bisphenol A di(meth)acrylate, hydroxypivalate neopentyl glycol di(meth)acrylate, polytetramethylene glycol di(meth)acrylate, polyethylene glycol diacrylate, or tripropylene glycol diacrylate; and a tri- or higher functional (meth)acrylate such as trimethylolpropane tri(meth)acrylate, pentaerythritol tri(meth)acrylate, pentaerythritol tetra(meth)acrylate, dipentaerythritol hexa(meth)acrylate, ditrimethylolpropane tetra(meth)acrylate, glycerine propoxy tri(meth)acrylate, or pentaerythritol ethoxy tetra(meth)acrylate.

The radically polymerizable compound preferably contains a (meth)acrylate modified with ethylene oxide or propylene oxide (hereinafter, also simply referred to as a “modified (meth)acrylate”). The modified (meth)acrylate is more photosensitive. In addition, the modified (meth)acrylate is more compatible with other composition components even at a high temperature. Furthermore, the modified (meth)acrylate is less likely to cause curing shrinkage, and therefore curling of a printed matter during image formation is less likely to occur.

Examples of the cationically polymerizable compound include an epoxy compound, a vinyl ether compound, and an oxetane compound.

Examples of the epoxy compound include: an alicyclic epoxy resin such as 3,4-epoxycyclohexylmethyl-3′,4′-epoxycyclohexane carboxylate, bis(3,4-epoxycyclohexylmethyl) adipate, vinylcyclohexene monoepoxide, ε-caprolactone modified 3,4-epoxycyclohexylmethyl 3′,4′-epoxycyclohexane carboxylate, 1-methyl-4-(2-methyloxiranyl)-7-oxabicyclo[4,1,0]heptane, 2-(3,4-epoxycyclohexyl-5,5-spiro-3,4-epoxy) cyclohexanone-meta-dioxane, or bis(2,3-epoxycyclopentyl) ether; an aliphatic epoxy compound such as a polyglycidyl ether of polyether polyol, obtained by adding one or more alkylene oxides (for example, ethylene oxide and propylene oxide) to an aliphatic polyhydric alcohol such as a diglycidyl ether of 1,4-butanediol, a diglycidyl ether of 1,6-hexanediol, a triglycidyl ether of glycerin, a triglycidyl ether of trimethylolpropane, a diglycidyl ether of polyethylene glycol, a diglycidyl ether of propylene glycol, ethylene glycol, propylene glycol, or glycerin; and an aromatic epoxy compound including a di- or polyglycidyl ether of bisphenol A or an alkylene oxide adduct thereof, a di- or polyglycidyl ether of hydrogenated bisphenol A or an alkylene oxide adduct thereof, and a novolac epoxy resin.

Examples of the vinyl ether compound include: a monovinyl ether compound such as ethyl vinyl ether, n-butyl vinyl ether, isobutyl vinyl ether, octadecyl vinyl ether, cyclohexyl vinyl ether, hydroxybutyl vinyl ether, 2-ethylhexyl vinyl ether, cyclohexane dimethanol monovinyl ether, n-propyl vinyl ether, isopropyl vinyl ether, isopropenyl ether-o-propylene carbonate, dodecyl vinyl ether, diethylene glycol monovinyl ether, or octadecyl vinyl ether; and a di- or tri-vinyl ether compound such as ethylene glycol divinyl ether, diethylene glycol divinyl ether, triethylene glycol divinyl ether, propylene glycol divinyl ether, dipropylene glycol divinyl ether, butanediol divinyl ether, hexanediol divinyl ether, cyclohexane dimethanol divinyl ether, or trimethylolpropane trivinyl ether.

Examples of the oxetane compound include 3-hydroxymethyl-3-methyloxetane, 3-hydroxymethyl-3-ethyl oxetane, 3-hydroxymethyl-3-propyl oxetane, 3-hydroxymethyl-3-normalbutyl oxetane, 3-hydroxymethyl-3-phenyloxetane, 3-hydroxymethyl-3-benzyloxetane, 3-hydroxyethyl-3-methyloxetane, 3-hydroxyethyl-3-ethyloxetane, 3-hydroxyethyl-3-propyloxetane, 3-hydroxyethyl-3-phenyloxetane, 3-hydroxypropyl-3-methyloxetane, 3-hydroxypropyl-3-ethyloxetane, 3-hydroxypropyl-3-propyloxetane, 3-hydroxypropyl-3-phenyloxetane, 3-hydroxybutyl-3-methyloxetane, 1,4 bis{[(3-ethyl-3-oxetanyl) methoxy]methyl}benzene, 3-ethyl-3-(2-ethylhexyloxymethyl) oxetane, and di[1-ethyl (3-oxetanyl)] methyl ether.

The content of the photopolymerizable compound can be, for example, 1.0% by mass or more and 97% by mass or less, and is preferably 30% by mass or more and 90% by mass or less with respect to the total mass of the active energy ray curable composition.

The photopolymerization initiator only needs to be able to initiate polymerization of the photopolymerizable compound. For example, when the active energy ray curable composition includes a radically polymerizable compound, the photopolymerization initiator can be a photoradical initiator, and when the active energy ray curable composition includes a cationically polymerizable compound, the photopolymerization initiator can be a photocationic initiator (photoacid generator).

The content of the photopolymerization initiator can be optionally set within a range in which the active energy ray curable composition is sufficiently cured by irradiation with an active energy ray and dischargeability of the active energy ray curable composition is not reduced. For example, the content of the photopolymerization initiator can be 0.1% by mass or more and 20% by mass or less, and preferably 1.0% by mass or more and 12% by mass or less with respect to the total mass of the active energy ray curable composition. Note that when the active energy ray curable composition can be sufficiently cured without the photopolymerization initiator, for example, when the active energy ray curable composition is cured by irradiation with an electron beam, the photopolymerization initiator is unnecessary.

Examples of the coloring material include a dye and a pigment. The coloring material is preferably a pigment from a viewpoint of forming an image with good weather resistance. The pigment can be selected, for example, from a yellow pigment, a red or magenta pigment, a blue or cyan pigment, and a black pigment according to the color or the like of an image to be formed.

The dispersant only needs to be able to disperse the pigment sufficiently. Examples of the dispersant include a hydroxy group-containing carboxylate, a salt of a long chain polyaminoamide and a high molecular weight acid ester, a salt of a high molecular weight polycarboxylic acid, a salt of a long chain polyaminoamide and a polar acid ester, a high molecular weight unsaturated acid ester, a high molecular copolymer, a modified polyurethane, a modified polyacrylate, a polyether ester type anion activator, a naphthalene sulfonic acid formalin condensate salt, an aromatic sulfonic acid formalin condensate salt, a polyoxyethylene alkyl phosphate, polyoxyethylene nonyl phenyl ether, and stearyl amine acetate.

The content of the dispersant can be, for example, 20% by mass or more and 70% by mass or less with respect to the total mass of the pigment.

Examples of the fixing resin include a (meth)acrylic resin, an epoxy resin, a polysiloxane resin, a maleic acid resin, a vinyl resin, a polyamide resin, nitrocellulose, cellulose acetate, ethyl cellulose, an ethylene-vinyl acetate copolymer, a urethane resin, a polyester resin, and an alkyd resin.

The content of the fixing resin can be, for example, 1.0% by mass or more and 10.0% by mass or less with respect to the total mass of the active energy ray curable composition.

Examples of the surfactant include: an anionic surfactant such as a dialkyl sulfosuccinate, an alkylnaphthalene sulfonate, or a fatty acid salt; a nonionic surfactant such as a polyoxyethylene alkyl ether, a polyoxyethylene alkyl allyl ether, an acetylene glycol, or a polyoxy ethylene-polyoxypropylene block copolymer; a cationic surfactant such as an alkylamine salt or a quaternary ammonium salt; a silicone-based surfactant; and a fluorine-based surfactant.

The content of the surfactant is preferably 0.001% by mass or more and less than 5.0% by mass with respect to the total mass of the active energy ray curable composition.

Examples of the gelling agent include a ketone wax, an ester wax, a petroleum-based wax, a vegetable-based wax, an animal-based wax, a mineral-based wax, a hydrogenated castor oil, a modified wax, a higher fatty acid, a higher alcohol, hydroxystearic acid, a fatty acid amide such as an N-substituted fatty acid amide or a special fatty acid amide, a higher amine, an ester of a sucrose fatty acid, a synthetic wax, dibenzylidene sorbitol, a dimer acid, and a dimer diol. Among these compounds, a ketone wax, an ester wax, a higher fatty acid, a higher alcohol, and a fatty acid amide are preferable, and a ketone wax or an ester wax in which carbon chains each having 9 or more and 25 or less carbon atoms are disposed on both sides across a keto group or an ester group is more preferable from a viewpoint of further enhancing a pinning property of the composition (ink).

The content of the gelling agent is preferably 1.0% by mass or more and 10.0% by mass or less with respect to the total mass of the active energy ray curable composition.

4-2. Physical Properties of Active Energy Ray Curable Composition

When the active energy ray curable composition (inkjet ink) is an ink not containing a gelling agent, the active energy ray curable composition preferably has a viscosity of 3 mPa·s or more and 20 mPa·s or less at 40° C. from a viewpoint of further enhancing ejectability from an inkjet head. When the active energy ray curable composition is an ink containing a gelling agent, the composition preferably has a viscosity of 3 mPa·s or more and 20 mPa·s or less at 80° C.

When the active energy ray curable composition (inkjet ink) contains a gelling agent, the active energy ray curable composition preferably has a phase transition temperature that causes a sol-gel phase transition at 40° C. or higher and 70° C. or lower. When the phase transition temperature of the active energy ray curable composition is 40° C. or higher, the active energy ray curable composition is thickened rapidly after landing on a substrate. Therefore, the degree of the wetting spread is more easily adjusted. When the phase transition temperature of the active energy ray curable composition is 70° C. or lower, at the time of ejection of the active energy ray curable composition from a discharge head having a composition temperature of usually about 80° C., the composition is unlikely to be gelled, and therefore the active energy ray curable composition can be more stably ejected.

The viscosity of the active energy ray curable composition at 40° C., the viscosity thereof at 80° C., and the phase transition temperature thereof can be determined by measuring a temperature change of dynamic viscoelasticity of the composition with a rheometer. Here, the viscosity and phase transition temperature are values obtained by the following method. The active energy ray curable composition is heated to 100° C., and the composition is cooled to 20° C. under conditions of a shear rate of 11.7 (l/s) and a temperature-lowering rate of 0.1° C./s while the viscosity is measured with a stress control type rheometer (Physica MCR301 (cone plate diameter: 75 mm, cone angle: 1.0°) manufactured by Anton Paar GmbH), and a temperature change curve of viscosity is thereby obtained. The viscosity at 80° C. and the viscosity at 25° C. are determined by reading the viscosity at 40° C. and the viscosity at 80° C. in the temperature change curve of viscosity, respectively. The phase transition temperature is determined as a temperature at which the viscosity is 200 mPa·s in the temperature change curve of viscosity.

### EXAMPLES

Hereinafter, specific Examples of the present invention will be described together with Comparative Examples, but the present invention is not limited thereto.

### Example 1

1. Active Energy Ray Curable Ink

The following pigment dispersant, photopolymerizable compound, and polymerization inhibitor were put in a stainless beaker, and heated and stirred for one hour while heating on a hot plate at 65° C.

Pigment dispersant: 9 parts by mass of Ajisper PB824 (manufactured by Ajinomoto Fine Techno Co., Ltd.)

Photopolymerizable compound: 70 parts by mass of tripropylene glycol diacrylate

Polymerization inhibitor: 0.02 parts by mass of Irgastab UV10 (manufactured by Ciba Japan K.K.)

The mixed solution was cooled to room temperature. Thereafter, 21 parts by mass of Pigment Red 122 (Chroma Fine Red 6112JC manufactured by Dainichiseika Co., Ltd.) was added thereto. The mixed solution was put in a glass bottle together with 200 g of zirconia beads each having a diameter of 0.5 mm. The glass bottle was tightly sealed, and the mixture was dispersed for eight hours with a paint shaker. Thereafter, the zirconia beads were removed to prepare pigment dispersion 1.

The following photopolymerizable compounds, photopolymerization initiators, gelling agent, and surfactant, and the pigment dispersant 1 were mixed, and heated and stirred at 100° C. Thereafter, the obtained liquid was filtered with a #3000 metal mesh filter under heating and then cooled to prepare ink 1.

Photopolymerizable compound: 29.9 parts by mass of polyethylene glycol #400 diacrylate

Photopolymerizable compound: 15.0 parts by mass of 4EO modified pentaerythritol tetraacrylate

Photopolymerizable compound: 23.0 parts by mass of 6EO modified trimethylolpropane triacrylate

Photopolymerization initiator: 6.0 parts by mass of DAROCUR TPO (manufactured by BASF)

Photopolymerization initiator: 1.0 part by mass of ITX (manufactured by DKSH Japan)

Photopolymerization initiator: 1.0 part by mass of DAROCUR EDB (manufactured by BASF)

Surfactant: 0.1 parts by mass of KF-352 (Shin-Etsu Chemical Co., Ltd.)

Gelling agent: 5.0 parts by mass of distearyl ketone (Kao product, Kao wax T1)

19.0 parts by mass of pigment dispersion 1

2. Image Formation and Evaluation

2-1. Test 1

An image was formed under the following conditions using an image forming device having the configuration illustrated in FIG. 4.

As the intermediate image former, a piezo type inkjet head and an inkjet head including an ink tank, a supply pipe, an antechamber ink tank immediately before a recording head, and a pipe with a filter were used. As the inkjet head, a line head type inkjet head having a recording resolution of 1,200 dpi×1,200 dpi was disposed by arranging piezo heads each having a nozzle diameter of 24 μm and a resolution of 512 dpi in a staggered arrangement. Ink was put in an ink tank in communication with the inkjet head, and 3.5 pl of ink 1 per drop heated to 80° C. was discharged at a droplet discharge rate of 6 m/sec, and was caused to land on a surface of the intermediate transfer body.

As the thickener, a UV-LED light source with a wavelength of 395 nm was used, and irradiation intensity was set to 30 mJ/cm². The intermediate image former formed a plurality of images on a surface of the intermediate transfer body, selectively emitted an active energy ray to the surface of the intermediate transfer body among the images of the plurality of intermediate images, and did not emit an active energy ray to surfaces of the intermediate images. The active energy ray was emitted to a moving image from an upstream side (back side of the image) at an angle inclined toward a moving direction.

As the intermediate transfer body, an endless belt having an axial length of 800 mm, obtained by laminating a silicone rubber elastic layer having a thickness of 300 μm, a reflective layer having a thickness of 100 nm, formed by vapor-depositing aluminum, and a polyproyrene (PP) transparent layer having a thickness of 300 μm in this order on a polyimide (PI) substrate layer having a thickness of 80 μm, was used. The intermediate transfer body was stretched in an inverted triangle shape by three support rollers (one of which was a pressure roller). As the pressure roller, a roller having φ100 and a rubber pressure of 10 mm was used. A load on the transferer by the pressure roller was set to 80 N.

As the conveyance path, a metal drum of a triple cylinder for printer, the metal drum sucking and holding a recording medium with an air suction chuck and conveying the recording medium, was used.

As the thickener, a UV-LED light source with a wavelength of 395 nm was used, and irradiation intensity was set to 100 mJ/cm².

As the recording medium, OK Top Coat having a basis weight of 84.9 g/m² and manufactured by Oji Paper Co., Ltd. was used.

To the image forming device, each recording medium was conveyed at 600 mm/s to form ten 30 cm×30 cm solid images and halftone images of 10% density.

An image formed on the recording medium was observed with a microscope, and no crushing of ink droplet was observed. The transfer ratio of ink droplets was higher.

2-2. Test 2

A similar intermediate transfer body to Test 1 was used except that the transparent layer was not included. An image was formed in a similar manner to Test 1 except that the entire surface of the intermediate transfer body was irradiated with an active energy ray with irradiation intensity from the thickener being 100 mJ/cm².

An image formed on the recording medium was observed with a microscope, and no crushing of ink droplet was observed. However, the transfer ratio of ink droplets was lower. This is considered to be because the front surface side and the back surface side of the ink were sufficiently cured by the irradiation with an active energy ray from the thickener, and the ink was not sufficiently transferred.

2-3. Test 3

A similar intermediate transfer body to Test 1 was used except that the transparent layer was not included. An image was formed in a similar manner to Test 1 except that the entire surface of the intermediate transfer body was irradiated with an active energy ray with irradiation intensity from the thickener being 10 mJ/cm².

An image formed on the recording medium was observed with a microscope, and crushing of ink droplet was observed at many places. Note that the transfer ratio of ink droplets was similar to that of Test 1. This is considered to be because the back surface side of the ink was not sufficiently thickened even by irradiation with an active energy ray from the thickener, and the ink was crushed at the time of transfer.

2-4. Test 4

A similar intermediate transfer body to Test 1 was used except that neither the transparent layer nor the reflective layer was included. An image was formed in a similar manner to Test 1 except that the entire surface of the intermediate transfer body was irradiated with an active energy ray with irradiation intensity from the thickener being 100 mJ/cm².

An image formed on the recording medium was observed with a microscope, and crushing of ink droplet was observed at many places. The transfer ratio of ink droplets was lower. A reason for this is considered to be the following. That is, the back surface side of the ink was not sufficiently thickened even by irradiation with an active energy ray from the thickener. Therefore, the ink was crushed at the time of transfer, and the front surface side of the ink was sufficiently cured by irradiation with an active energy ray from the thickener. Therefore, the ink was not sufficiently transferred.

2-5. Test 5

A similar intermediate transfer body to Test 1 was used except that neither the transparent layer nor the reflective layer was included. An image was formed in a similar manner to Test 1 except that the entire surface of the intermediate transfer body was irradiated with an active energy ray with irradiation intensity from the thickener being 10 mJ/cm².

An image formed on the recording medium was observed with a microscope, and crushing of ink droplet was observed at many places. Note that the transfer ratio of ink droplets was similar to that of Test 1. This is considered to be because the back surface side of the ink was not sufficiently thickened even by irradiation with an active energy ray from the thickener, and the ink was crushed at the time of transfer.

By using the intermediate transfer body according to an embodiment of the present invention, it is possible to suppress crushing of the active energy ray curable ink and to improve transferability in the intermediate transfer type image forming method. Therefore, the present invention is expected to expand the range of application of the intermediate transfer type image forming method using the active energy ray curable ink, and to contribute to development and spread of the technology in the field.

Although embodiments of the present invention have been described and illustrated in detail, the disclosed embodiments are made for purposes of illustration and example only and not limitation. The scope of the present invention should be interpreted by terms of the appended claims.

What is claimed is:

1. An intermediate transfer body used for image formation using an active energy ray, the intermediate transfer body comprising:
a transmissive member that is disposed on an outermost layer of the intermediate transfer body and transmits an active energy ray; and
a reflective member that reflects the active energy ray that has passed through the transmissive member to a front layer side of the intermediate transfer body.

2. The intermediate transfer body according to claim 1, wherein
the transmissive member transmits an ultraviolet ray, and
the reflective member reflects an ultraviolet ray.

3. The intermediate transfer body according to claim 1, wherein
the transmissive member transmits an electron beam, and
the reflective member reflects an electron beam.

4. The intermediate transfer body according to claim 1, wherein the reflective member has an integral spectral reflectance of 100 or more for light with a wavelength of 360 nm or more and 450 nm or less.

5. The intermediate transfer body according to claim 1, wherein the reflective member is formed into a film shape and disposed in contact with the outermost layer.

6. The intermediate transfer body according to claim 1, wherein the reflective member contains metal.

7. The intermediate transfer body according to claim 6, wherein the reflective member contains aluminum.

8. The intermediate transfer body according to claim 1, wherein the reflective member contains a particulate reflective material.

9. The intermediate transfer body according to claim 8, wherein the reflective member contains titanium dioxide.

10. The intermediate transfer body according to claim 1, wherein the transmissive member has a transmittance of 70% or more for light with a wavelength of 360 nm or more and 450 nm or less.

11. The intermediate transfer body according to claim 1, wherein the transmissive member is substantially free of a material that reflects an active energy ray.

12. The intermediate transfer body according to claim 1, wherein the transmissive member is formed into a film shape to constitute the outermost layer.

13. The intermediate transfer body according to claim 12, wherein the transmissive member is formed into a film shape having a film thickness of 5 μm or more.

14. The intermediate transfer body according to claim 1, used for image formation by an inkjet method.

15. An image forming device comprising:
the intermediate transfer body according to claim 1;
an intermediate image former that applies an active energy ray curable composition to a surface of the intermediate transfer body to form an intermediate image;
a thickener that irradiates the surface of the intermediate transfer body with an active energy ray to thicken the active energy ray curable composition; and
a transferer that transfers an intermediate image including the thickened active energy ray curable composition onto a recording medium.

16. The image forming device according to claim 15, wherein the thickener selectively irradiates an area where the intermediate image is not formed on the surface of the intermediate transfer body with the active energy ray.

17. The image forming device according to claim 16, wherein
the intermediate image former forms a plurality of the intermediate images on the surface of the intermediate transfer body, and
the thickener selectively irradiates the surface of the intermediate transfer body among the plurality of intermediate images with an active energy ray.

18. The image forming device according to claim 16, wherein the thickener emits the active energy ray to the moving surface of the intermediate transfer body at an angle inclined toward the moving direction.

19. The image forming device according to claim 15, wherein the intermediate image former applies the active energy ray curable composition to the surface of the intermediate transfer body by an inkjet method.

20. An image forming method comprising:
applying an active energy ray curable composition to a surface of the intermediate transfer body according to claim 1 to form an intermediate image;
irradiating the surface of the intermediate transfer body with an active energy ray to thicken the active energy ray curable composition; and
transferring an intermediate image including the thickened active energy ray curable composition onto a recording medium.

21. The image forming method according to claim 20, wherein in the irradiating the active energy ray, an area where the intermediate image is not formed on the surface of the intermediate transfer body is selectively irradiated with the active energy ray.

22. The image forming method according to claim 21, wherein in the forming the intermediate image, a plurality of the intermediate images is formed on the surface of the intermediate transfer body, and
in the irradiating the active energy ray, the surface of the intermediate transfer body among the plurality of intermediate images is selectively irradiated with an active energy ray.

23. The image forming method according to claim 21, wherein in the irradiating the active energy ray, the moving surface of the intermediate transfer body is irradiated with the active energy ray at an angle inclined toward the moving direction.

24. The image forming method according to claim 20, wherein in the forming the intermediate image, the active energy ray curable composition is applied to the surface of the intermediate transfer body by an inkjet method.
